(19) United States
(12) Patent Application Publication
(10) Pub. No.: US 2006/0051487 A1
(43) Pub. Date: Mar. 9, 2006

(54) Processed meats comprising emulsified liquid shortening compositions comprising dietary fiber gel, water and lipid

(75) Inventors: Triveni P. Shukla, New Berlin, WI (US); Gregory J. Halpern, Vernon Hills, IL (US)

Correspondence Address: Timothy J. Fullin, 1011 Campus Drive, Mundelein, IL, 60060, US

(73) Assignee: Circle Group Holdings, Inc.

(21) Appl. No.: 11/264,119

(22) Filed: Nov. 1, 2005

Related U.S. Application Data
(63) Continuation-in-part of application No. 10/689,269, filed on Oct. 20, 2003, now abandoned.

(51) Int. Cl. A23B 4/20; A23D 9/00

(52) U.S. Cl. 426/601; 426/332

(57) ABSTRACT

According to the present invention, fat and caloric content of processed meats can be reduced by the replacement of a portion fat content normally found in processed meats with an amount of emulsified liquid shortening composition comprising dietary fiber gel, water and lipid. The result is that fat and caloric content of processed meats can be manipulated with minimal effect on taste and texture. Furthermore, these emulsified mixtures, or “emulsified liquid shortening compositions comprising dietary fiber gel, water and lipid”, can further comprise functional foods such as high omega three and omega six oils and pure omega three and omega six fatty acids, medium chain triglyceride, beta carotene, calcium estearate, vitamin E, bioflavonoids, fagopyritrol, polyphenolic antioxidants of vegetable origin, lycopene, luteine and soluble fiber, for example Beta-Glucan derived from yeast, and other soluble fibers derived from grain, flax seed, and other vegetable and fruit fiber sources, and any combination thereof. Hence, in addition to reducing fat and caloric content of processed meats, further health benefits can be achieved by replacing a portion of fat with emulsified liquid shortening compositions comprising dietary fiber gel, water and lipid.

### CROSS-REFERENCE TO RELATED APPLICATIONS

This application is a Continuation-in-Part Application of U.S. patent application Ser. No. 10/689,269 filed on Oct. 20, 2003, the entirety of which is incorporated herein.

### STATEMENT REGARDING FEDERALLY SPONSORED RESEARCH/DEVELOPMENT

The present invention does not involve any form of federally sponsored research or development.

### BACKGROUND OF THE INVENTION

The present invention relates to processed meats comprising emulsified liquid shortening compositions comprising dietary fiber gel, water and lipid. Recent media attention to the global problem of obesity demonstrates a need for greater availability of foods with low caloric and fat content. This is especially true for foods that typically have high fat and caloric content, such as processed meats.

Processed meats typically comprise some fat. Other ingredients can vary according to the type of processed meat and the recipe followed, but typically, processed meats are high in both fat and caloric content. Examples of processed meats include but are not limited to all types of sausages including hot dogs and fish dogs, ground meats, pressed meats, and the like, and for purposes of this document include vegetable burgers.

In recent years, some companies have begun to offer reduced fat processed meats. This variety of processed meat, however, often fails to retain the desirable taste and texture of processed meats comprising higher fat contents.

The absence of a means to reduce the fat and caloric content of processed meats while still producing a desirably flavored and textured processed meat presents an unmet need in today's food industry.

### BRIEF SUMMARY OF THE INVENTION

It is an object of the present invention to provide a unique composition of matter embodied by low-calorie and low-fat processed meats. This reduction in caloric and fat content answers an unmet need in the food industry to provide the consuming public with a healthier, higher fiber alternative to traditional types of processed meats that typically are inherently fattening. It is another object of the present invention to provide processed meats that have been fortified with insoluble fiber and other functional foods.

Dietary fiber gels for calorie reduced foods hold the key to meeting this need. Dietary fiber gels for calorie reduced foods are fully described in U.S. Pat. No. 5,766,662 (the '662 patent), which is herein incorporated by reference in its entirety. These dietary fiber gels comprise insoluble dietary fibers consisting of morphologically disintegrated cellular structures, and are characterized by their ability to retain large amounts of water. These amorphous insoluble cellulosic fiber gels are produced by shearing agricultural by-products, such as seed brans, hulls, and so forth, under alkaline conditions. Amorphous insoluble cellulosic fiber gels in a hydrated form can exist as gel, and in the dehydrated form as flakes and powders. Additionally, their high viscosity at low solid levels characterizes these dietary fiber gels. Other insoluble fibers derived from cereals, grains and legumes consist of morphologically in tact cellular structures, and thus impart a gritty texture to the foods in which they are contained. The amorphous insoluble cellulosic fiber gels disclosed in the '662 patent (also herein referred to as dietary fiber gels), however, are amorphous in nature and consist of morphologically disintegrated cellular structures; they thus impart a smoother texture than other insoluble fiber formulations. The physically smooth morphology is readily revealed under electron microscopic magnification of amorphous insoluble cellulosic fiber gel. The smooth morphology is also demonstrated by approximately 60 percent to 90 percent reduction in birefringence when compared to microcrystalline dietary fiber products. The smooth morphology reflects the amorphous nature of the insoluble compounds that constitute amorphous insoluble cellulosic fiber gel.

More specifically, the present invention utilizes emulsified mixtures of the amorphous insoluble cellulosic fiber gels disclosed in the '662 patent, the emulsified mixtures further comprising, at a minimum, water and lipid. These emulsified mixtures are fully described in and are the subject of U.S. patent application Ser. No. 10/669,731, filed Sep. 24, 2003 which is herein incorporated by reference in its entirety. These emulsified mixtures, or “emulsified liquid shortening compositions comprising dietary fiber gel, water and lipid”, can further comprise functional foods such as high omega three and omega six oils and pure omega three and omega six fatty acids, medium chain triglyceride, beta carotene, calcium stearate, vitamin E, bioflavonoids, fagopyritrol, polyphenolic antioxidants of vegetable origin, lycopene, luteine and soluble fiber, for example Beta-Glucan derived from yeast, and other soluble fibers derived from grain, flax seed, and other vegetable and fruit fiber sources, and any combination thereof. Hence, in addition to reducing fat and caloric content of processed meats, further health benefits can be achieved by replacing a portion of fat with emulsified liquid shortening compositions comprising dietary fiber gel, water and lipid.

According to the present invention, fat and caloric content can be reduced by the replacement of the fat normally found in processed meats with emulsified liquid shortening compositions comprising dietary fiber gel, water and lipid. This replacement of fat does not adversely affect either 69 the taste or texture of the processed meats. In fact, the added emulsified liquid shortening helps to increase the moisture content of the meat while simultaneously lowering the fat content. The result is that fat and caloric content of processed meats can be manipulated with minimal effect on taste and texture, and as stated above, additional health benefits can be achieved through consumption of processed meats comprising emulsified liquid shortening compositions comprising dietary fiber gel, water and lipid when functional foods are included in the formulations.

Further objects, advantages and features of the present invention will present themselves in the following detailed description.

### DETAILED DESCRIPTION OF THE PREFERRED EMBODIMENT

This invention is directed to processed meats comprising emulsified liquid shortening compositions comprising dietary fiber gel, water and lipid. According to the present invention, fat and caloric content can be reduced by the replacement of the fat normally found in processed meats with emulsified liquid shortening compositions comprising dietary fiber gel, water and lipid (hereinafter “emulsified liquid shortening”). This replacement of fat does not adversely affect either the taste or texture of the processed meats. The result is that fat and caloric content of processed meats can be manipulated with minimal effect on taste and texture.

For purposes of this document, processed meats include traditional processed meats, including all types of sausages including hot dogs and fish dogs, ground meats, pressed meats, and the like, and vegetable-derived meat substitutes, for example vegetable burgers. Traditional processed meats can be formulated such that the processed meat comprises 0.1 percent to 5.0 percent dietary fiber gel solids by replacing an appropriate amount, that is, an amount prorated to deliver this range of dietary fiber gel solids, of fat, including oil and liquid shortening, with an amount of emulsified liquid shortening. Vegetable-derived meat substitutes such as vegetable burgers can be formulated such that the processed meat comprises 0.1 percent to 7.0 percent dietary fiber gel solids by replacing an appropriate amount, that is, an amount prorated to deliver this range of dietary fiber gel solids, of fat, including oil and liquid shortening, with an amount of emulsified liquid shortening.

The result is that fat and caloric content of processed meats can be manipulated with minimal effect on taste and texture, and as stated above, additional health benefits can be achieved through consumption of processed meats comprising emulsified liquid shortening compositions comprising dietary fiber gel, water and lipid when functional foods are included in the formulations.

### EXAMPLES

The emulsified shortening in each of the following examples comprise 25% amorphous insoluble cellulosic fiber gel, 29% oil, 45% water and 1% emulsifier.

### Example 1

### Smoked Sausage Comprising Emulsified Liquid Shortening Compositions Comprising Dietary Fiber Gel, Water and Lipid

TABLE 1

| Ingredient | Without % | With % |
|---|---|---|
| Meat Blend (50% pork, 50% Beef; total | 76.25 | |
| fat content 40%) | | |
| Lean Meat Blend (30% pork, 70% Beef; | | 68.00 |
| total fat content 28%) | | |
| Water | 17.25 | — |
| Nonfat dry milk | 2.5 | — |
| Emulsified Liquid Shortening | | 27.20 |
| Salt | 1.75 | 1.81 |
| 80% Whey Protein | 1.25 | 1.63 |
| Spice and Cure | 1.00 | 1.36 |
| TOTAL | 100.00 | 100.00 |
| Fat % | 30.50 | 25.84 |

Grind meats through 0.95 cm (⅜ in.) plate;
Blend meats and other ingredients together in a mixer for 5 minutes;
Regrind through 0.48 cm ( 3/16 in.) plate;
Stuff into edible collagen casings; Place in smoke and heat;
Cook to an internal temperature of 62° C. (144° F.).

Two formulations of Smoked Sausage are presented in Table 1. One sausage formulation, labeled here as “Without”, represents a typical formulation for Smoked Sausage. A Smoked Sausage formulation, labeled here as “With” demonstrates a variation on the “Without” formulation and comprises Emulsified Liquid Shortening Compositions Comprising Dietary Fiber Gel, Water and Lipid. The formulation comprising Emulsified Liquid Shortening Compositions Comprising Dietary Fiber Gel, Water and Lipid exhibits a 15.3% reduction in fat compared to its counterpart formulation and comprises 6.80% (by weight) amorphous insoluble cellulosic fiber gel solids. Thus, in addition to eliminating over 15% of the fat from a representative typical Smoked Sausage formulation, healthy dietary fiber has been added, making the “With” formulation a vehicle of delivery for insoluble dietary fiber.

### Example 2

### Beef Patty Comprising Emulsified Liquid Shortening Compositions Comprising Dietary Fiber Gel, Water and Lipid

TABLE 2

| Ingredient | Without % | With % |
|---|---|---|
| Beef (Fat = 44%) | 86.00 | |
| Lean Beef (Fat = 28%) | | 72.99 |
| Water | 11.50 | — |
| 80% Whey Protein Concentrate | 2.00 | 2.03 |
| Salt | 0.5 | 0.65 |
| Emulsified Liquid Shortening | | 24.33 |
| TOTAL | 100.00 | 100.00 |
| Fat % | 37.84 | 26.52 |

Grind meat through 9.5 to 12.7 (⅜-½ inch) plate;
blend meat, protein, salt, . . . for 2 minutes;
hold at <32 deg F. or 0 deg C. in order to prevent fat separation;
grind through a ⅛ inch plate and form patties.

Two formulations of Beef Patties are presented in Table 2. One formulation, labeled here as “Without”, represents a typical formulation for Beef Patties. A Beef Patty formulation, labeled here as “With” demonstrates a variation on the “Without” formulation and comprises Emulsified Liquid Shortening Compositions Comprising Dietary Fiber Gel, Water and Lipid. The formulation comprising Emulsified Liquid Shortening Compositions Comprising Dietary Fiber Gel, Water and Lipid exhibits a 29.9% reduction in fat compared to its counterpart formulation and comprises 6.08% (by weight) amorphous insoluble cellulosic fiber gel solids. Thus, in addition to eliminating nearly 30% of the fat from a representative typical Beef Patty formulation, healthy dietary fiber has been added, making the “With” formulation a vehicle of delivery for insoluble dietary fiber.

### Example 3

### Bologna Comprising Emulsified Liquid Shortening Compositions Comprising Dietary Fiber Gel, Water and Lipid

TABLE 3

| Ingredient | Without % | With % |
|---|---|---|
| Pork (Fat = 45%) | 45.00 | 22.90 |
| Ice Water | 27.87 | — |
| Beef (Fat = 35%) | 21.27 | — |
| Ground Beef Round (Fat = 12%) | — | 52.67 |
| Whey Protein Concentrate | 3.00 | — |
| Emulsified Liquid Shortening | | 20.00 |
| Salt | 2.30 | 2.60 |
| Sugar | 1.00 | 1.10 |
| White Pepper | 0.3 | 0.35 |
| Nutmeg | 0.13 | 0.15 |
| Ginger | 0.13 | 0.15 |
| Sodium Erythrobate | 0.054 | 0.060 |
| Sodium Nitrite | 0.015 | 0.017 |
| TOTAL | 100.00 | 100.00 |
| Formula Fat, % | 27.69 | 22.43 |

Add meat, salt, curing ingredients, whey protein concentrate and half of the ice to cutter.
Drop the temperature to about 4° C. (39° F.).
Chop until a stable emulsion forms.
Add the remaining ice and spices.
Heat to about 13° C. (55° F.).
Stuff in cellulose casings and cook to an internal temperature of 77° C. (171° F.).
After cooking, there will be more water retained and thus, as a percentage of the formulation, fat content will be further lowered via dilution.

Two formulations of Bologna are presented in Table 3. One formulation, labeled here as “Without”, represents a typical formulation for Bologna. A Bologna formulation, labeled here as “With” demonstrates a variation on the “Without” formulation and comprises Emulsified Liquid Shortening Compositions Comprising Dietary Fiber Gel, Water and Lipid. The formulation comprising Emulsified Liquid Shortening Compositions Comprising Dietary Fiber Gel, Water and Lipid exhibits a 19% reduction in fat compared to its counterpart formulation and comprises 9.00% (by weight) amorphous insoluble cellulosic fiber gel solids. Thus, in addition to eliminating nearly 20% of the fat from a representative typical Bologna formulation, healthy dietary fiber has been added, making the “With” formulation a vehicle of delivery for insoluble dietary fiber.

I claim:

1. Processed meat, the meat having a formulation, the meat comprising emulsified liquid shortening composition comprising amorphous insoluble cellulosic fiber, water and lipid,
wherein the emulsified liquid shortening composition comprising amorphous insoluble cellulosic fiber, water and lipid is added in a prorated amount such that solids contained within amorphous insoluble cellulosic fiber represent 0.1 percent to 5.0 percent by weight of the overall meat formulation, and
the emulsified liquid shortening composition comprising amorphous insoluble cellulosic fiber, water and lipid replaces an amount of fat used in an otherwise identical recipe of processed meat that uses no emulsified liquid shortening compositions comprising amorphous insoluble cellulosic fiber, water and lipid.

2. Hot dogs, the hot dogs having a formulation, the hot dogs comprising emulsified liquid shortening composition comprising amorphous insoluble cellulosic fiber, water and lipid,
wherein the emulsified liquid shortening composition comprising amorphous insoluble cellulosic fiber, water and lipid is added in a prorated amount such that solids contained within the amorphous insoluble cellulosic fiber represent 0.1 percent to 5.0 percent by weight of the overall hot dog formulation, and
the emulsified liquid shortening composition comprising amorphous insoluble cellulosic fiber, water and lipid replaces an amount of fat used in an otherwise identical recipe of hot dogs that uses no emulsified liquid shortening compositions comprising amorphous insoluble cellulosic fiber, water and lipid.

3. Sausage, the sausage having a formulation, the sausage comprising emulsified liquid shortening composition comprising amorphous insoluble cellulosic fiber, water and lipid,
wherein the emulsified liquid shortening composition comprising amorphous insoluble cellulosic fiber, water and lipid is added in a prorated amount such that solids contained within the amorphous insoluble cellulosic fiber represent 0.1 percent to 5.0 percent by weight of the overall sausage formulation, and
the emulsified liquid shortening composition comprising amorphous insoluble cellulosic fiber, water and lipid replaces an amount of fat used in an otherwise identical recipe of sausage that uses no emulsified liquid shortening compositions comprising amorphous insoluble cellulosic fiber, water and lipid.

4. Pressed meat, the pressed meat having a formulation, the pressed meat comprising emulsified liquid shortening composition comprising amorphous insoluble cellulosic fiber, water and lipid,
wherein the emulsified liquid shortening composition comprising amorphous insoluble cellulosic fiber, water and lipid is added in a prorated amount such that solids contained within the amorphous insoluble cellulosic fiber represent 0.1 percent to 5.0 percent by weight of the overall pressed meat formulation, and
the emulsified liquid shortening composition comprising amorphous insoluble cellulosic fiber, water and lipid replaces an amount of fat used in an otherwise identical recipe of pressed meat that uses no emulsified liquid shortening compositions comprising amorphous insoluble cellulosic fiber, water and lipid.

5. Ground meat, the ground meat having a formulation, the ground meat comprising emulsified liquid shortening composition comprising amorphous insoluble cellulosic fiber, water and lipid,
wherein the emulsified liquid shortening composition comprising dietary fiber gel, water and lipid is added in a prorated amount such that solids contained within the amorphous insoluble cellulosic fiber represent 0.1 percent to 5.0 percent by weight of the overall ground meat formulation, and
the emulsified liquid shortening composition comprising amorphous insoluble cellulosic fiber, water and lipid replaces an amount of fat used in an otherwise identical recipe of ground meat that uses no emulsified liquid shortening compositions comprising amorphous insoluble cellulosic fiber, water and lipid.

6. Vegetable-derived meat substitute, the vegetable-derived meat substitute having a formulation, the vegetable-derived meat substitute comprising emulsified liquid shortening composition comprising amorphous insoluble cellulosic fiber, water and lipid,
wherein the emulsified liquid shortening composition comprising amorphous insoluble cellulosic fiber, water and lipid is added in a prorated amount such that solids contained within the amorphous insoluble cellulosic fiber represent 0.1 percent to 7.0 percent by weight of the overall vegetable-derived meat substitute formulation, and
the emulsified liquid shortening composition comprising amorphous insoluble cellulosic fiber, water and lipid replaces an amount of fat used in an otherwise identical recipe of vegetable-derived meat substitute that uses no emulsified liquid shortening compositions comprising dietary fiber gel, water and lipid.
